(19) United States
(12) Patent Application Publication
(10) Pub. No.: US 2021/0255638 A1
(43) Pub. Date: Aug. 19, 2021

(54) Area Division and Path Forming Method and Apparatus for Self-Moving Device and Automatic Working System

(71) Applicant: Positec Power Tools (Suzhou) Co., Ltd., Suzhou (CN)

(72) Inventors: Steven Ma, Houghton, MI (US); John Hoffman, Houghton, MI (US)

(21) Appl. No.: 16/923,363

(22) Filed: Jul. 8, 2020

(30) Foreign Application Priority Data
Feb. 19, 2020 (CN) 202010102227.2
Jul. 6, 2020 (CN) 202010642954.8

(51) Int. Cl. G05D 1/02; G06K 9/72; G06K 9/00; A01D 34/00

(52) U.S. Cl. CPC G05D 1/0274; G06K 9/726; G06K 9/00805; G06F 3/04842; G05D 1/0221; G05D 1/0219; G05D 1/0246; A01D 34/008

(57) ABSTRACT

This specification provides a movement area division method and apparatus for a smart self-moving device, a movement path forming method and apparatus for a smart self-moving device, and an automatic working system. In an embodiment, a preset recognition model is first invoked, and image data that is obtained from an electronic map database and includes a target working area and electronic map data of correlated coordinate information is recognized and divided, to recognize a plurality of working areas and provide boundary figures of these working areas. A corresponding global positioning system (GPS) reference point is marked within the boundary of each working area. Regular movement paths of the self-moving device are generated based on the reference points and boundary figures. These movement paths cover all division areas. The self-moving device autonomously completes walking according to the division areas and the set paths.

### BACKGROUND

### Technical Field

This specification relates to the field of robotics technology, and in particular, to a movement area division method and apparatus for a self-moving device, a path forming method and apparatus for a self-moving device, and an automatic working system.

### Related Art

With the development of robotics related technologies, an increasingly large number of self-moving working devices gradually emerge and are applied to people's daily work and life.

Before a self-moving working device is specifically applied, a user usually needs to manually guide the self-moving working device to move one lap along the boundary of a working area, so that the self-moving working device determines and records the boundary of the working area in which the self-moving working device is required to work, and the self-moving working device can generate a corresponding movement path for the working area.

At present, there is an urgent need for a method that can simplify the operations of a user and effectively and automatically divide a movement area for a self-moving device and generating a movement path for a self-moving device.

### SUMMARY

This specification provides a movement area division method and apparatus for a self-moving device, a movement path forming method and apparatus for a self-moving device, and an automatic working system, so that the operations of a user are simplified, the use experience of the user is improved, and the efficiency of dividing a movement area and generating a movement path for a self-moving device is improved, thereby resolving the technical problems of low efficiency of dividing a movement area and generating a movement path, complex operations of the user, and poor use experience in existing methods.

A path forming method for a self-moving device provided in this specification includes:

obtaining electronic map data from an electronic map database, where the electronic map data includes image data including a target working area, and the image data is correlated to coordinate information;

invoking a preset recognition model, and determining a semantic map based on the electronic map data, where the semantic map includes a recognized workable area and/or workable area boundary, and the workable area and/or workable area boundary is correlated to the coordinate information;

marking at least one reference point on the semantic map or the electronic map data; and

forming a movement path by using the reference point as a start point and based on the workable area and/or workable area boundary on the semantic map.

In an embodiment, the marking at least one reference point on the semantic map or the electronic map data includes: automatically determining a point in the target working area as the reference point according to the semantic map.

In an embodiment, the automatically determining a point in the target working area as the reference point according to the semantic map includes: automatically determining a corner point of the workable area and/or a turning point of the workable area boundary as the reference point.

In an embodiment, the marking at least one reference point on the semantic map or the electronic map data includes: presenting the semantic map or the electronic map data to a user; receiving a selection operation of the user on the semantic map or the electronic map data; and marking the reference point on the semantic map or the electronic map data according to the selection operation.

In an embodiment, the method further includes: generating a first drive circuit instruction, where the first drive circuit instruction instructs to move to the reference point or an adjacent range area of the reference point; and executing, by the self-moving device, the first drive circuit instruction by performing positioning and based on coordinate information of the reference point.

In an embodiment, the invoking a preset recognition model, and determining a semantic map based on the electronic map data includes: invoking the preset recognition model, and generating one or more sub-areas based on the electronic map data, where the workable area of the semantic map includes the sub-area; and the marking at least one reference point on the semantic map includes: marking at least one reference point in each sub-area.

In an embodiment, the method further includes: generating a second drive circuit instruction, where the second drive circuit instruction instructs to move, after movement is completed in a corresponding sub-area based on one of the reference points, to a reference point corresponding to another sub-area to start movement in the another sub-area.

In an embodiment, the semantic map further includes a recognized passable non-working area and/or passable non-working area boundary, and the passable non-working area and/or passable non-working area boundary is correlated to the coordinate information; and the moving, after movement is completed in a corresponding sub-area based on one of the reference points, to a reference point corresponding to another sub-area includes: moving, after movement is completed in the corresponding sub-area based on one of the reference points, to the reference point corresponding to the another sub-area through the passable non-working area.

In an embodiment, the method further includes: recognizing the workable area boundary through visual recognition; and generating a third drive circuit instruction based on the recognized boundary, where the third drive circuit instruction instructs to move along the workable area boundary and/or steer to move away from the workable area boundary.

In an embodiment, the method further includes: recognizing the workable area boundary through visual recognition; operating the self-moving device to move along the workable area boundary, and recording the coordinate information in a movement process through positioning; and generating a working area map of the target working area according to the recorded coordinate information.

In an embodiment, the forming a movement path includes forming a regular movement path.

In an embodiment, the forming a regular movement path includes: generating a round-trip movement path, where the round-trip movement path includes a former path section and a latter path section, and the latter path section is offset from the former path section by a preset distance.

In an embodiment, the method further includes: determining, through visual recognition, whether there is an obstacle at a position at a preset distance in front of a current position; and generating an adjusted path if it is determined that there is an obstacle at the position at the preset distance in front of the current position, where the adjusted path is used for avoiding the obstacle.

In an embodiment, the method further includes: generating the movement path based on the integration of a positioning signal, where the positioning signal is obtained from inertial navigation, a speedometer or satellite navigation.

In an embodiment, the electronic map database includes an online satellite map database.

In an embodiment, the invoking a preset recognition model, and determining a semantic map based on the electronic map data includes: performing convolution processing on the image data in the electronic map data by using a trained neural network model, to obtain the semantic map.

In an embodiment, the self-moving device includes a self-moving lawn treatment device, and the target working area includes a target lawn.

This specification further provides a computer-readable storage medium, storing computer instructions, the instructions, when executed, implementing: obtaining electronic map data from an electronic map database, where the electronic map data includes image data including a target working area, and the image data is correlated to coordinate information; invoking a preset recognition model, and determining a semantic map based on the electronic map data, where the semantic map includes a recognized workable area and/or workable area boundary, and the workable area and/or workable area boundary is correlated to the coordinate information; marking at least one reference point on the semantic map or the electronic map data; and forming a movement path by using the reference point as a start point and based on the workable area and/or workable area boundary on the semantic map.

This specification further provides a path forming apparatus for a self-moving device, including: an obtaining module, configured to obtain electronic map data from an electronic map database, where the electronic map data includes image data including a target working area, and the image data is correlated to coordinate information; a recognition module, configured to: invoke a preset recognition model, and determine a semantic map based on the electronic map data, where the semantic map includes a recognized workable area and/or workable area boundary, and the workable area and/or workable area boundary is correlated to the coordinate information; a marking module, configured to mark at least one reference point on the semantic map or the electronic map data; and a movement path forming module, configured to form a movement path by using the reference point as a start point and based on the workable area and/or workable area boundary on the semantic map.

This specification further provides a path forming apparatus for a self-moving device, including: a memory, storing computer-readable instructions; and a processor, when processing the computer-readable instructions, performing the following steps: obtaining electronic map data from an electronic map database, where the electronic map data includes image data including a target working area, and the image data is correlated to coordinate information; invoking a preset recognition model, and determining a semantic map based on the electronic map data, where the semantic map includes a recognized workable area and/or workable area boundary, and the workable area and/or workable area boundary is correlated to the coordinate information; marking at least one reference point on the semantic map or the electronic map data; and forming a movement path by using the reference point as a start point and based on the workable area and/or workable area boundary on the semantic map.

This specification further provides an automatic working system, including a self-moving device and an application installed on a user terminal side, where the application includes: an obtaining procedure, including: obtaining electronic map data from an electronic map database, where the electronic map data includes image data including a target working area, and the image data is correlated to coordinate information; a recognition procedure, including: invoking a preset recognition model, and determining a semantic map based on the electronic map data, where the semantic map includes a recognized workable area and/or workable area boundary, and the workable area and/or workable area boundary is correlated to the coordinate information; and a marking procedure: marking at least one reference point on the semantic map or the electronic map data; the self-moving device includes a communication module, communicating with a client, and obtaining coordinate information of the reference point from the client after the application is executed; and the self-moving device further includes a positioning module, forming a movement path by monitoring an output of the positioning module and based on the coordinate information of the reference point.

This specification further provides an automatic working system, including: a self-moving device, where the self-moving device includes a housing, a movement module mounted at the housing, and a control module controlling the movement module to drive the self-moving device to move; the self-moving device further includes a positioning module, configured to output coordinate information of the self-moving device; the automatic working system further includes a storage unit, storing: a semantic map generation procedure, including: obtaining electronic map data from an electronic map database, where the electronic map data includes image data including a target working area, and the image data is correlated to the coordinate information; invoking a preset recognition model, and determining a semantic map based on the electronic map data, where the semantic map includes a recognized workable area and/or workable area boundary, and the workable area and/or workable area boundary is correlated to the coordinate information; and a marking procedure, including: marking at least one reference point on the semantic map or the electronic map data; the automatic working system executes the semantic map generation procedure and the marking procedure, to determine coordinate information of the reference point; and the control module controls the movement module by monitoring an output of the positioning module and based on the coordinate information of the reference point to form a movement path.

By means of the movement area division method and apparatus for a smart self-moving device, the movement path forming method and apparatus for a smart self-moving device, and the automatic working system provided in this specification, a preset recognition model is invoked, and electronic map data that is obtained from an electronic map database and includes image data of a target working area correlated to coordinate information is recognized and divided, to recognize a plurality of working areas and provide boundary figures of these working areas. A corresponding global positioning system (GPS) reference point is marked within the boundary of each working area. Regular movement paths of the self-moving device are generated based on the reference points and boundary figures. These movement paths cover all division areas. The self-moving device autonomously completes walking according to the division areas and the set paths. Therefore, a user does not need to guide a self-moving device in advance to move around a target working area, and the self-moving device can automatically divide a movement area and generate a corresponding movement path according to a specific service task, so that the operations of the user are simplified, the use experience of the user is improved, and the efficiency of dividing a movement area and generating a movement path for a self-moving device is improved, thereby resolving the technical problems of low efficiency of dividing a movement area and generating a movement path, complex operations of the user, and poor use experience in existing methods.

### BRIEF DESCRIPTION OF THE DRAWINGS

To describe the embodiments of this specification more clearly, the following briefly introduces the accompanying drawings for describing the embodiments. The accompanying drawings in the following description show merely some embodiments recorded in this specification, and a person of ordinary skill in the art may still derive other drawings from the accompanying drawings without creative efforts.

FIG. 1 is a schematic diagram of a scenario in which a self-moving lawn treatment device is applied based on an existing method;

FIG. 2 is a schematic flowchart of a path forming method for a self-moving device according to an embodiment of this specification;

FIG. 3 is a schematic structural diagram of a self-moving lawn treatment device according to an embodiment;

FIG. 4 is a schematic diagram of an embodiment in which a path forming method for a self-moving device according to an embodiment of this specification is applied in a scenario example;

FIG. 5 is a schematic diagram of an embodiment in which a path forming method for a self-moving device according to an embodiment of this specification is applied in a scenario example;

FIG. 6 is a schematic diagram of an embodiment in which a path forming method for a self-moving device according to an embodiment of this specification is applied in a scenario example;

FIG. 7 is a schematic diagram of an embodiment in which a path forming method for a self-moving device according to an embodiment of this specification is applied in a scenario example;

FIG. 8 is a schematic diagram of an embodiment in which a path forming method for a self-moving device according to an embodiment of this specification is applied in a scenario example;

FIG. 9 is a schematic diagram of an embodiment in which a path forming method for a self-moving device according to an embodiment of this specification is applied in a scenario example;

FIG. 10 is a schematic diagram of an embodiment in which a path forming method for a self-moving device according to an embodiment of this specification is applied in a scenario example;

FIG. 11 is a schematic diagram of an embodiment in which a path forming method for a self-moving device according to an embodiment of this specification is applied in a scenario example;

FIG. 12 is a schematic diagram of an embodiment in which a path forming method for a self-moving device according to an embodiment of this specification is applied in a scenario example;

FIG. 13 is a schematic diagram of an embodiment in which a path forming method for a self-moving device according to an embodiment of this specification is applied in a scenario example;

FIG. 14 is a schematic structural diagram of a path forming apparatus for a self-moving device according to an embodiment of this specification;

FIG. 15 is a schematic structural diagram of a path forming apparatus for a self-moving device according to an embodiment of this specification;

FIG. 16(a) is a schematic diagram of a path of a self-moving device according to an embodiment of this specification;

FIG. 16(b) is a schematic diagram of a path of a self-moving device according to an embodiment of this specification;

FIG. 17 is a flowchart of movement control of a self-moving device according to an embodiment of this specification;

FIG. 18(a) to FIG. 18(e) are schematic diagrams of the division of a movement area according to an embodiment of this specification; and

FIG. 19 is a schematic diagram of a boundary correction process according to an embodiment of this specification.

### DETAILED DESCRIPTION

To make persons skilled in the art understand the technical solutions in this specification better, the following describes the technical solutions in the embodiments of this specification with reference to the accompanying drawings in the embodiments of this specification. Apparently, the described embodiments are merely some but not all of the embodiments of this specification. All other embodiments obtained by persons of ordinary skill in the art based on the embodiments of this specification shall fall within the protection scope of this specification.

In an existing path forming method for a self-moving device, before the generation of a specific movement path and a specific operation, a user usually needs to first manually guide a self-moving device to move one lap along the boundary of a target working area in which the target working area is required to work, so that the self-moving device acquires and records coordinate information of points on the boundary of the target working area. After the boundary of the target working area is determined, the self-moving device can automatically generate a corresponding movement path based on the determined boundary of the target working area to perform specific movement and work.

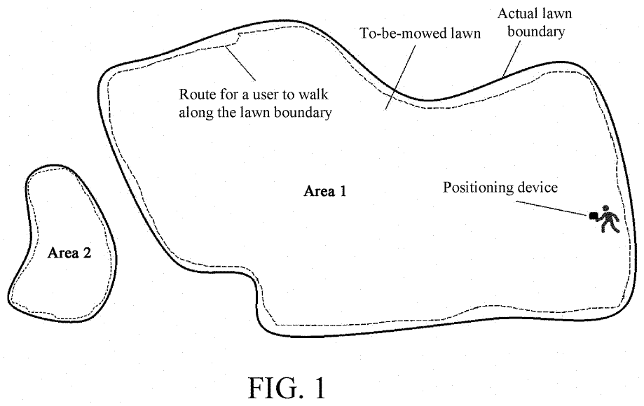

For example, referring to FIG. 1, a self-moving device used by a user is a self-moving lawn treatment device. Based on the existing method, the user first needs to hold a detachable positioning device provided on the self-moving lawn treatment device to walk one lap around an actual lawn boundary of a lawn that requires mowing, so that the positioning device may obtain coordinate information of points on the lawn boundary through satellite positioning during the walking of the user, so as to determine a lawn that requires mowing work and the lawn boundary. After the foregoing processing is completed, the self-moving lawn treatment device can automatically generate a movement path for a lawn mower and move on the lawn to cut grass. However, based on the foregoing method, the user needs to manually carry the positioning device of the self-moving lawn treatment device to move one lap around the boundary of the lawn, causing complexity and an increased workload to the user. Especially, when a lawn that requires mowing covers a relatively large area, as shown in FIG. 1, it inevitably takes a lot of time and labor of the user to carry the positioning device of the self-moving lawn treatment device to finish walking one lap along the boundary of the lawn, leading to relatively poor use experience of the user.

It may be seen that in the existing method, the user needs to guide the self-moving device in advance to move around the target working area before a corresponding movement path can be generated for the target working area, leading to the technical problems of low efficiency of generating the movement path and complex operations of the user during specific implementation.

For the foregoing case, it is conceived to use a more simple and intelligent method to generate a corresponding movement path for a self-moving device in this application. Specifically, it is conceived that a preset recognition model trained in advance based on a convolutional neural network (CNN) may be used to perform recognition processing on image data that is obtained from an electronic map database and includes a target working area and electronic map data of correlated coordinate information to obtain a semantic map including a recognized workable area and/or workable area boundary. A corresponding reference point may be alternatively marked on the semantic map, and a movement path of the self-moving device is then generated based on the reference point. In this way, a user only needs to perform simple operations of selecting and instructing to obtain electronic map data, but no longer needs to guide a self-moving device in person to move around a target working area, and the self-moving device can automatically generate a movement path for the target working area according to a specific service task, so that the operations of the user are simplified, the use experience of the user is improved, and the efficiency of generating a movement path for a self-moving device is improved, thereby effectively resolving the technical problems of low efficiency of generating a movement path, complex operations of the user, and poor use experience in existing methods.

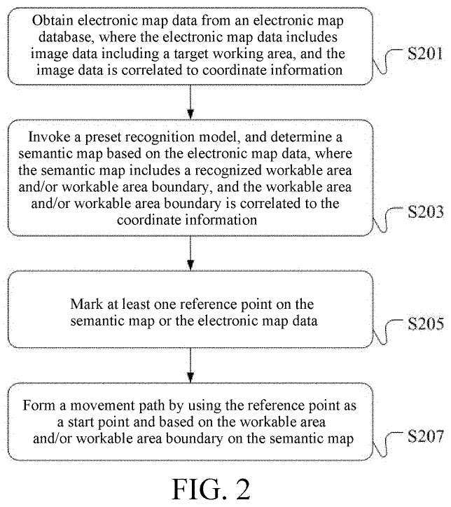

Based on the foregoing considerations, this application provides a path forming method for a self-moving device provided in this specification. Reference may be made to FIG. 2. The method may be specifically applied to a self-moving device, may be applied to a client device that is used by a user and is correlated to a self-moving device or may be applied to a cloud server of a website platform that communicates with a self-moving device. Specifically, the method may include the following content.

S201: Obtain electronic map data from an electronic map database, where the electronic map data includes image data including a target working area, and the image data is correlated to coordinate information.

In an embodiment, the image data is correlated to GPS coordinate information.

In an embodiment, the self-moving device may be specifically referred to as a self-moving working device. Specifically, the self-moving working device may include a self-moving lawn treatment device (for example, an autonomous lawn mower) or may include a self-moving cleaning device (for example, an autonomous sweeper or an autonomous snow plow) or may include a self-moving monitoring robot or the like. Certainly, the self-moving device listed above is only an example of description. During specific implementation, according to a specific application scenario, the self-moving device may further include another type of self-moving device in addition to the device listed above. This is not limited in this specification.

In an embodiment, during a specific operation, the user may first set a working area for the self-moving device to work or the self-moving device may autonomously recognize and determine a working area to work. Further, the self-moving device may generate a corresponding movement path for the working area, then move according to the movement path through positioning and navigation, and complete corresponding service work.

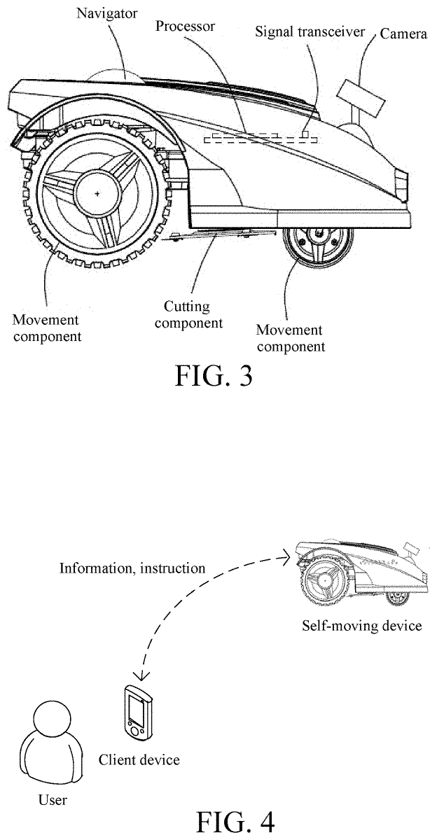

In an embodiment, the self-moving lawn treatment device is used as an example. Reference may be made to FIG. 3. The self-moving lawn treatment device may specifically include component structures such as a signal transceiver, a processor, a navigator, a cutting component, and a movement component. The signal transceiver may be configured to interact with the client device used by the user. Further, the signal transceiver may further interact with the cloud server. The navigator such as a GPS module may be configured to interact with a satellite navigation system. The processor may be configured to perform specific data processing. The movement component may be configured to execute an instruction to move the self-moving lawn treatment device. The cutting component may be configured to execute an instruction to perform work such as lawn mowing.

Certainly, the component structures listed above are only examples of description. During specific implementation, other component structures in addition to the component structures listed above may further be introduced according to a specific application scenario and working requirement to form the self-moving lawn treatment device. For example, some self-moving lawn treatment devices may further be provided with a posture detector, a laser rangefinder, a direction sensor, a camera, and the like.

In an embodiment, the self-moving lawn treatment device may further be specifically provided with an operation control panel, for example, a touch display screen or an operation panel arranged with functional keys. In this way, the user may perform a correlated operation on the operation control panel to initiate a corresponding instruction to control the self-moving lawn treatment device to perform a specific work task.

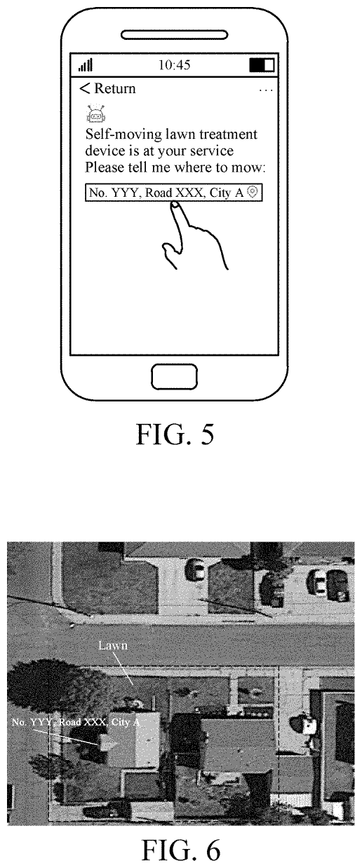

In an embodiment, the user may use the client device separate from the self-moving lawn treatment device to control the self-moving lawn treatment device to perform a specific work task. Reference may be made to FIG. 4. The client device may be coupled to the signal transceiver of the self-moving lawn treatment device in a wired or wireless manner, so that the client device and the self-moving lawn treatment device may exchange information and instructions in a wired or wireless manner.

The client device may specifically include a front-end device that is applied to a user side and can implement functions such as data input and data transmission. Specifically, the client device may be, for example, a desktop computer, a tablet computer, a notebook computer, a smart phone or a remote control. Alternatively, the client device may be a software application that can be run in an electronic device. For example, the client device may be an APP run on a mobile phone.

In an embodiment, the user may use the mobile phone on which an APP correlated to the self-moving lawn treatment device is installed in advance as the client device, so as to use the mobile phone to conveniently control the self-moving lawn treatment device to perform various specific work tasks such as determining the boundary of a lawn that requires mowing, automatically generating a map of the lawn that requires mowing or performing mowing on the lawn that requires mowing.

In an embodiment, the electronic map database may specifically include an online satellite map database. For example, the electronic map database may be an online satellite map database of Google or may be an online satellite map database of Baidu or may be an online satellite map database of AutoNavi. The electronic map database stores map data of different location areas. The map data of the location area includes an image (for example, an aerial image) of the corresponding location area and also includes coordinate information of the corresponding location area. The coordinate information may specifically include latitude and longitude coordinates.

In an embodiment, the electronic map data may specifically include the image data including the target working area, and the image data is correlated to the coordinate information.

The target working area may be specifically understood as a range area in which the self-moving device is required by the user to work. Specifically, for example, the target working area may be a lawn that is located in front of the user's door and requires mowing by the self-moving lawn treatment device or may be a road on which a self-moving snow plow is required by the user to remove snow. Certainly, the target working area listed above is only an example of description. During specific implementation, the target working area may be alternatively another type of range area according to a specific application scenario. This is not limited in this specification.

The electronic map data may be specifically the image data including the target working area. The image data may be specifically an aerial image of the target working area or may scan the image data or the like of the target working area. The image data may include, in addition to the target working area, an adjacent range area of the target working area. Specifically, the electronic map data may further carry coordinate information of the target working area. One piece of coordinate information may be correspondingly correlated to one location point in the image data. Certainly, a particular precision error exists in the electronic map data. Therefore, in this embodiment, a tolerable offset error within a particular range is allowed in a correspondence between the coordinate information and the location point in the image data.

In an embodiment, the user may perform a corresponding operation on the client device to set identifier information of the target working area, for example, the address or GPS coordinates of the target working area. Further, the client device may access the electronic map database according to the identifier information to obtain corresponding electronic map data and send the electronic map data to the self-moving device. In this way, the self-moving device may obtain the electronic map data, and the processor of the self-moving device may perform subsequent processing on the electronic map data. Certainly, during specific implementation, the client device may first obtain the electronic map data in the foregoing manner, and the client device directly performs subsequent processing on the electronic map data. The electronic map data does not need to be sent to the self-moving device. In addition, the user may perform a corresponding operation on the operation control panel of the self-moving device to control the self-moving device to actively obtain the electronic map data.

In an embodiment, the electronic map data obtained in the foregoing manner according to the identifier information of the target working area, for example, the address of the target working area, set by the user may further include electronic map data of a peripheral area other than the target working area. For example, the electronic map data obtained in the foregoing manner according to a residential address set by the user includes electronic map data of a lawn at the user's residence, and may also include electronic map data of a part of a neighbor's lawn. Obviously, the part of the neighbor's lawn included in the electronic map data may be not the target working area that the user actually wants to set.

To avoid the foregoing case and make the obtained electronic map data more precise, it is preferable that only the electronic map data of the target working area is included, so as to reduce the interference with subsequent processing from electronic map data of other peripheral areas. In the process of specifically obtaining electronic map data, while the electronic map database is accessed according to the identifier information of the target working area to obtain corresponding electronic map data, a correlated database (for example, a residential information database of the user's residential area) may be searched to obtain reference data such as the user's residential area information and the user's residential yard range information correlated to the identifier information. Electronic map data of a peripheral area other than the target working area in the electronic map data may be further filtered out according to the reference data, and only the electronic map data of the target working area is kept and used as the eventually obtained relatively precise electronic map data.

Certainly, specified operation data for the range of the target working area may further be obtained at the same time when the map data is specifically obtained, and the electronic map database may further be accessed by combining the specified operation data of the user and the target working area set by the user to obtain matching electronic map data or the like that corresponds to the identifier information and only includes the range of the target working area specified by the user. The specified operation data of the user may be specifically operation data or the like in the range of a specific target working area further drawn by using a gesture operation in the electronic map data that is presented by the user and corresponds to the identifier information of the target working area set by the user.

In an embodiment, the user may also directly perform a corresponding operation on the operation control panel of the self-moving device to set the identifier information of the target working area, so that the self-moving device may receive the identifier information of the target working area and directly search and download the corresponding electronic map data or the like from the electronic map database according to the identifier information of the target working area set by the user.

Certainly, the manner of obtaining electronic map data listed above is only an example of description. During specific implementation, another appropriate manner may be used according to a specific application scenario and processing requirement to obtain corresponding electronic map data from the electronic map database. This is not limited in this specification.

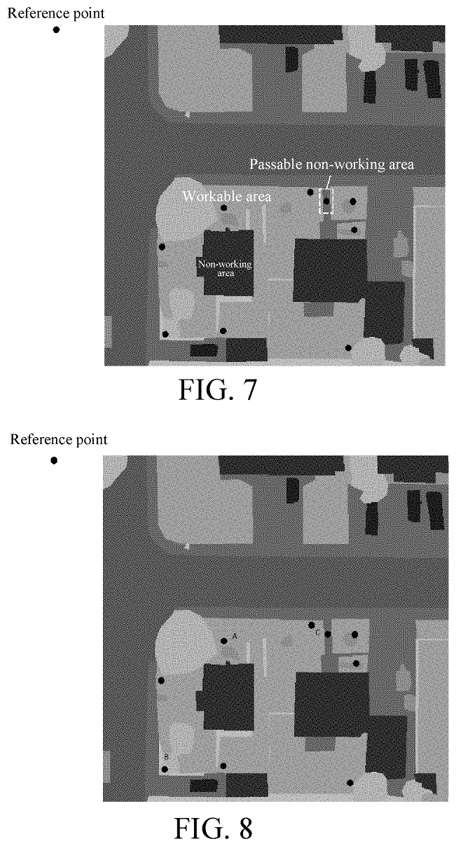

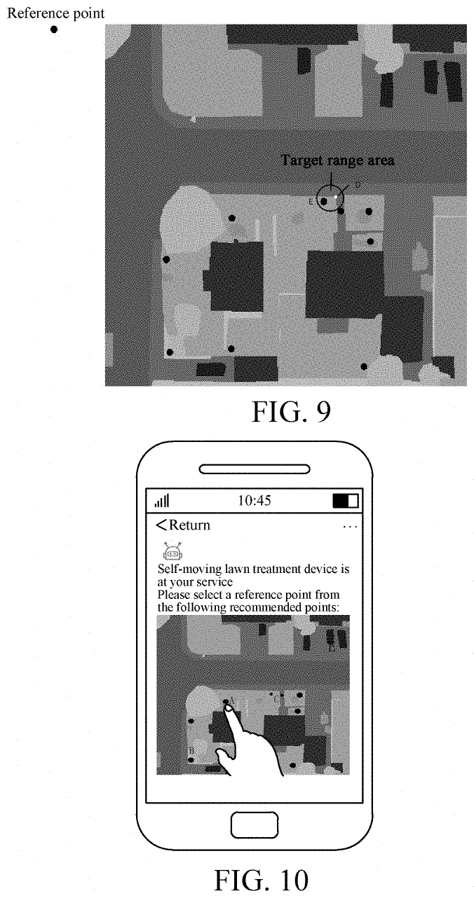

In an embodiment, specifically, in another example, the user wants to use the self-moving lawn treatment device to perform mowing work on a lawn in the user's residential yard. Reference may be made to FIG. 5. The user may enter the user's residential address in an address input interface of an APP correlated to the self-moving lawn treatment device on a used client mobile phone. For example, the address “No. YYY, Road XXX, City A” is sent to the self-moving lawn treatment device. After receiving the address, the self-moving lawn treatment device may use a connected network (for example, a Wireless Fidelity (Wi-Fi) network) to access a corresponding electronic map database, and search and download electronic map data corresponding to the address from the electronic map database. Specifically, the electronic map data may be electronic map data of a preset range area (for example, a 400-m² square range area with the address as the center point) with the address as the center point. Reference may be made to FIG. 6. In another embodiment, the user may enter the GPS coordinates of a target lawn in the APP to obtain corresponding electronic map data. When the user is on a lawn in the user's residential yard, the user may use the APP to directly obtain the GPS coordinates of the current location. The self-moving lawn treatment device may be disposed on the target lawn, and the GPS coordinates of the self-moving lawn treatment device is obtained. The electronic map data obtained in the foregoing manner actually may further include a neighbor's lawn or the like of the user and electronic map data of a peripheral area other than the range of the target working area (that is, the lawn in the user's residential yard) set by the user. In this case, the residential information database of the user's residential area may be searched to obtain the user's residential yard range information. Electronic map data of the part of the neighbor's lawn in the upper part of FIG. 6 may further be filtered or cropped in combination with the residential yard range information. In this way, only the electronic map data keeping only the lawn in the user's residential yard in the lower part of FIG. 6 is eventually obtained.

Certainly, electronic map data that includes both the lawn in the user's residential yard and a peripheral area (for example, a part of a neighbor's lawn) of the lawn in the user's residential yard may be first displayed to the user, and the user is prompted to specify the target working area by using an operation such as a gesture in the displayed electronic map data. In this case, the user may use a gesture operation to define, in the displayed electronic map data in FIG. 6, a range area that is in the lower part of FIG. 6 and belongs to the user's residential lawn, so as to specify a range of the target working area based on the electronic map data. Further, the electronic map data that is determined from FIG. 6 according to the specified operation of the user and includes only the target working area may be acquired, and subsequently only the part of electronic map data may be correspondingly processed.

S203: Invoke a preset recognition model, and determine a semantic map based on the electronic map data, where the semantic map includes a recognized workable area and/or workable area boundary, and the workable area and/or workable area boundary is correlated to the coordinate information.

In an embodiment, the preset recognition model may specifically include a model that is trained in advance based on a CNN model and can recognize a workable area and/or workable area boundary from the image data.

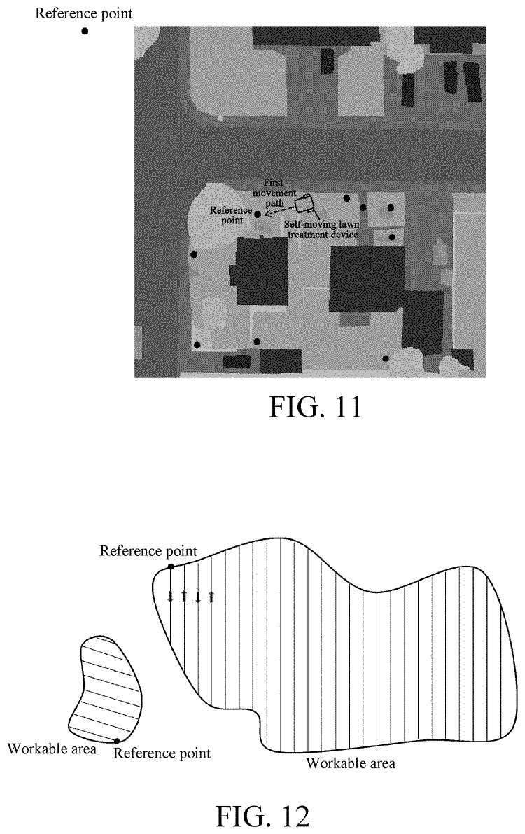

The workable area may be specifically understood as an area that is located in the target working area and allows the self-moving device to normally move, enter, and perform corresponding work. For example, a to-be-mowed lawn that allows the self-moving lawn treatment device to move, enter, and perform cutting work is recognized from the image data by using the preset recognition model. Reference may be made to FIG. 7.

The workable area boundary may be specifically understood as a range area at a border position between a workable area and a non-working area.

In this embodiment, the preset recognition model may recognize a workable area and/or workable area boundary, and may further recognize a non-working area in the image data. The non-working area may specifically include an area other than the target working area in the image data. For example, the preset recognition model recognizes, from the image data, an area of a street, a house or the like other than the to-be-mowed lawn or an area of a neighbor's lawn. The non-working area may specifically include an impassable non-working area that does not allow the self-moving device to normally move and enter. For example, the preset recognition model recognizes an area of an obstacle such as a rockery or a pond from the image data. The non-working area may further specifically include a passable non-working area that allows the self-moving device to normally move and enter but does not allow the self-moving device to perform specific service work. For example, the preset recognition model recognizes an area of a corridor, a bridge or the like from the image data.

In this embodiment, objects recognized by the preset recognition model from the image data are categorized and labels are assigned to implement area categorization. Examples are as follows:

| Label | Examples of objects |
|---|---|
| Road | Asphalt road |
| Sidewalk | Concrete sidewalk, concrete terrace |
| Car | Any vehicle |
| Building | Any building |
| Fence | Independent wall body |
| Vegetation | Bush, tree (an object that is too large to mow) |
| Landform | Soil, sand, water, landscape, timber pile, garbage |
| Grass | Grass to be cut |

In an embodiment, the semantic map may be specifically understood as map data that is recognized and extracted from the electronic map data, includes a workable area and/or workable area boundary recognized by the preset recognition model, and carries coordinate information correlated to the workable area and/or workable area boundary. Specifically, the processor of the self-moving device or the client device used by the user may perform reading, and determine, according to the semantic map from the range areas corresponding to the electronic map data, which range areas are workable areas, which range areas are non-working areas, which range areas are workable area boundaries, and the like.

In this embodiment, the preset recognition model is invoked to perform division into a plurality of sub-areas. The sub-areas are, for example, two lawns separated by a sidewalk. An entire yard (and/or the boundary of the yard) or each sub-area (and/or the boundary of the sub-area) can be recognized by invoking the preset recognition model.

In an embodiment, during specific implementation, the client device, the processor of the self-moving device or the cloud server may invoke the preset recognition model in the foregoing manner to process the electronic map data to obtain the semantic map.

Specifically, the electronic map data may be inputted as a model input into the preset recognition model, and the preset recognition model may be run. During specific running of the preset recognition model, convolution processing may be performed on the image data of the electronic map by using a trained CNN in the model to obtain a corresponding semantic map and output the semantic map as a model output. In this way, the corresponding semantic map may be determined based on the electronic map data.

In an embodiment, when a clear boundary (for example, a boundary from a neighbor's neighboring lawn) is not found after the preset recognition model is invoked to process the electronic map data, the user may manually select a boundary, for example, draw the boundary on the APP or select a particular compensational offset in an area lacking a clear boundary.

S205: Mark at least one reference point on the semantic map or the electronic map data.

In an embodiment, the reference point may be understood as a position point correlated to the target working area. Specifically, the reference point may be a position point in the workable area, or may be position point at the position of the workable area boundary, or may be a position point in a passable non-working area other than the workable area. The passable non-working area may be specifically understood as a range area that allows the self-moving device to move and pass but does not allow the self-moving device to perform work.

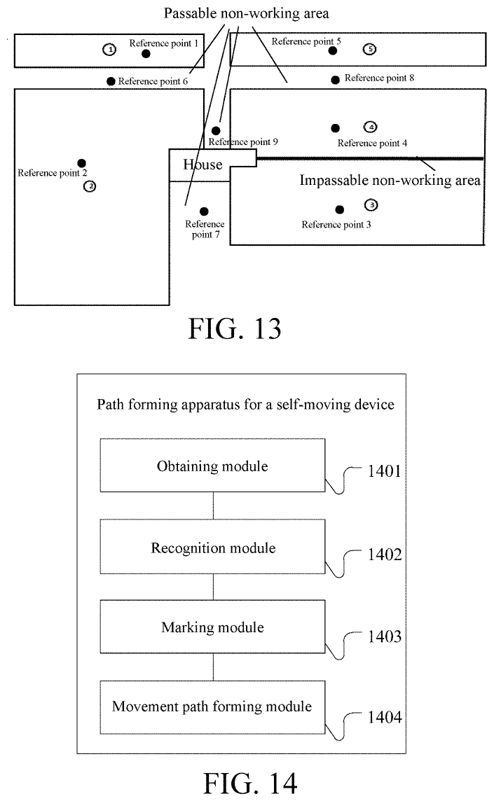

Specifically, for example, reference may be made to FIG. 8. The foregoing reference point may include a position point A at the central position in the to-be-mowed lawn. The reference point may also include an intersection between two adjacent boundary lines on a lawn (or a point at a corner position on the lawn), that is, a corner point of the workable area and/or a turning point of the workable area boundary, for example, a point B in FIG. 8. The reference point may also be a point C or the like on a corridor that allows the self-moving lawn treatment device to pass but does not allow mowing work.

In an embodiment, during specific implementation, one or more reference points may be determined and marked on the foregoing semantic map. Specifically, for example, when the target working area includes two separated sub-areas, one reference point may be determined and marked in each sub-area in the semantic map. In another example, for one target working area, because of a working requirement, a central position point, an upper-left-corner position point, and a lower-right-corner position point of the target working area need to be simultaneously examined on site, so that three reference points may be determined and marked in one target working area in the semantic map.

In an embodiment, during specific implementation, the division of working areas is automatically generated according to the recognition of a lawn and an environment around the lawn during image recognition in combination with artificial intelligence. According to area blocks, one or more working areas (lawns) may be automatically generated, and at least one GPS reference point is obtained in each sub-area.

In an embodiment, during specific implementation, the client device or the processor of the self-moving device may automatically determine, according to the semantic map in combination with a working requirement, a point in a target range area as the reference point. In addition, coordinate information of the reference point may further be determined and recorded according to coordinate information of the semantic map.

In an embodiment, the target range area may be a preset range area at an intersection between two adjacent working area boundaries of the workable area, that is, a corner point of the workable area and/or a turning point of the workable area boundary. Alternatively, the target range area may be specifically a preset range area or the like at a central point of the workable area. The area range size of the preset range area may be flexibly set according to a specific case.

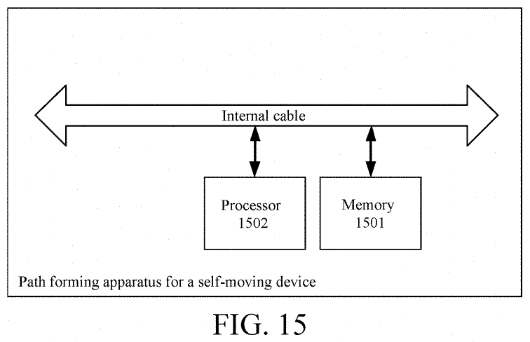

Specifically, for example, referring to FIG. 9, a circular range area with the intersection D between two boundary lines at the upper right corner of the to-be-mowed lawn being the center and a radius of 1 meter may be used as the target range area.

Certainly, it needs to be noted that the target range area listed above is only an example of description. During specific implementation, the target working area may be alternatively another type of range area according to a specific application scenario.

In an embodiment, during specific implementation, the target range area may be first automatically determined according to the semantic map, and a point satisfying a preset requirement may further be determined from the target range area as the reference point. Certainly, a point satisfying the preset requirement may be directly determined as the reference point. For example, a corner point of the workable area and/or a turning point of the workable area boundary is determined as the reference point.

The point satisfying the preset requirement may be specifically a reachable position point or a point located in the workable area in the target range area.

Specifically, for example, referring to FIG. 9, a point E located in the workable area may be determined from the target range area as the reference point.

In an embodiment, during specific implementation, to improve the use experience of a user and make it convenient for the user to flexibly choose a point satisfying the user's requirement as a reference point, image data of the semantic map or the electronic map may be first displayed to the user, and a selection operation of the user on the image data of the semantic map or the electronic map may be received. According to the foregoing operation, a position point selected by the user is then determined as a reference point, and the reference point is marked in the data of the semantic map or electronic map. Further, the coordinate information of the reference point may further be determined and recorded according to coordinate information of the map.

In an embodiment, during specific implementation, the client device or the processor of the self-moving device may first determine one or more reference points as recommended points. The recommended points are simultaneously displayed in the semantic map displayed to the user. The user may click a recommended point in the displayed map to perform an operation. In this case, the recommended point chosen by the user may be determined as a final reference point. Certainly, instead of clicking any recommended point, the user may otherwise click another point in the map to perform an operation. In this case, the user may determine the point otherwise clicked by the user as the final reference point.

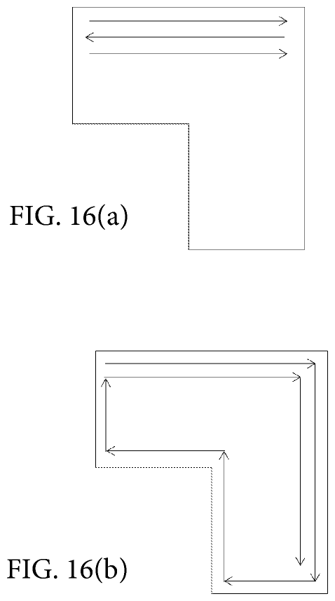

Specifically, for example, referring to FIG. 10, the processor of the self-moving lawn treatment device automatically finds a plurality of points (for example, intersections between a plurality of adjacent boundary lines on the lawn) satisfying a requirement from a lawn, so that the plurality of points may first be determined as recommended points, and the plurality of recommended points are then sent to the client device. Further, the client device may use a screen to display to the user a map showing the plurality of recommended points. In this case, the user may perform, according to the user's plan or preference, a corresponding operation on the map displayed by the client device to choose a recommended point that the user intends to use as the reference point. For example, the user may click a point E in the plurality of displayed recommended points on a display screen of a mobile phone. Further, the mobile phone may receive and respond to the selection operation of the user to finally determine the recommended point E chosen by the user as the reference point.

In this embodiment, the self-moving lawn treatment device may further be provided with a display device such as a display screen. During specific implementation, the self-moving lawn treatment device may alternatively use the display device to directly display to the user the map showing the plurality of recommended points. The user may perform a selection operation on the plurality of recommended points displayed by the self-moving lawn treatment device to choose a recommended point. The self-moving lawn treatment device may receive the selection operation of the user, and determine, from the plurality of recommended points according to the selection operation, the recommended point chosen by the user as the reference point.

In an embodiment, during specific marking of a reference point, the reference point may be marked on the semantic map, and the reference point may be marked in the electronic map data. Specifically, the self-moving lawn treatment device provides two data options for marking a reference point to the user according to the user's preference; and receives and responds to the selection operation of the user to mark the reference point on the semantic map chosen by the user or the electronic map data chosen by the user. In this way, a variety of marking requirements of different users may be satisfied, thereby further improving the use experience of the user.

S207: Form a movement path by using the reference point as a start point and based on the workable area and/or workable area boundary on the semantic map.

In an embodiment, the movement path may be specifically understood as a route for the self-moving device to correspondingly move in a workable area or a passable non-working area.

In an embodiment, during specific implementation, a corresponding movement path is flexibly formed according to a specific application scenario, a specific work task that the self-moving device currently needs to perform, and the reference point.

In an embodiment, specifically, the movement path may be a movement path for instructing the self-moving device to move to a reference point or an adjacent range area of a reference point. Based on the movement path, the self-moving device may automatically move to the reference point or the adjacent range area of the reference point. The movement path may be alternatively a movement path formed with the reference point as the start point of the path. For example, the movement path may be a round-trip movement path that uses the reference point as the start point and covers the workable area. The movement path may be alternatively a movement path for instructing the self-moving device to move from one sub-area to another separate sub-area. The movement path may be alternatively a movement path along a workable area boundary. The movement path may be alternatively a movement path for instructing the self-moving device to steer away from a workable area boundary or the like.

Certainly, the movement path listed above is only an example of description. During specific implementation, according to a specific application scenario and work task, the movement path may further include another type of movement path in addition to the movement path listed above. This is not limited in this specification.

In an embodiment, during specific implementation, a drive circuit instruction correlated to a movement path may be generated according to a specific application scenario and work task. The self-moving device may obtain the drive circuit instruction, and perform the drive circuit instruction through positioning and based on the coordinate information of the reference point, to control the self-moving device to move according to the movement path.

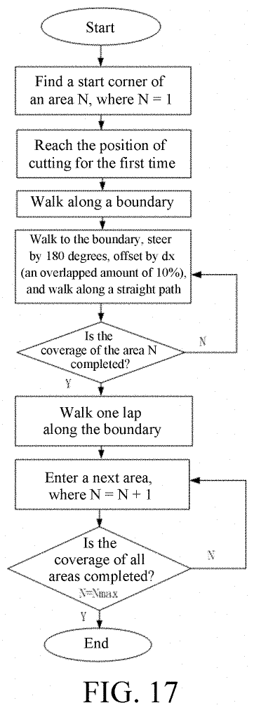

In an embodiment, during specific implementation, referring to FIG. 11, a first movement path for instructing the self-moving device to move from a current position to a reference point or an adjacent range area of a reference point may be generated according to the processing of the client device or the self-moving device. Correspondingly, a first drive circuit instruction is generated. After receiving the first drive circuit instruction, the self-moving device may perform the first drive circuit instruction through navigation positioning and based on the coordinate information of the reference point, to control the self-moving device to move along the first movement path to a reference point or an adjacent range area of a reference point.

In an embodiment, after performing the first drive circuit instruction to control the self-moving device to move to the reference point or the adjacent range area of the reference point, the self-moving device may further form a new movement path with the reference point as the start point according to a specific work task.

In an embodiment, the forming a movement path includes forming a regular movement path.

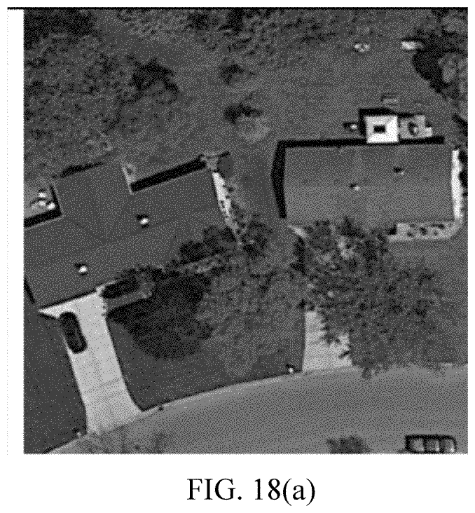

In an embodiment, a work task that needs to be performed by the self-moving device needs to cover an entire workable area. For example, the self-moving lawn treatment device needs to perform mowing processing in an area with a lawn that requires mowing is located. After moving to the reference point or the adjacent range area of the reference point, the self-moving device may further generate, based on the reference point, a round-trip movement path that can cover the entire workable area as a new movement path. Reference may be made to FIG. 12 for details. The movement path may be parallel linear paths. For example, the movement path may be transverse (or longitudinal) parallel linear paths, as shown by the right-side area in FIG. 12 or may be oblique paths along a boundary, as shown by the left-side area in FIG. 12. The start point of the round-trip movement path may be a reference point. The round-trip movement path may specifically include one or more round-trip path pairs. Each round-trip path pair further specifically includes a former path and a latter path. A preset distance may be offset between the former path and the latter path in one same round-trip path pair. The preset distance may also be offset between two adjacent paths in two adjacent round-trip path pairs, for example, the latter path in the former round-trip path pair and the former path in the latter round-trip path pair of the two adjacent round-trip path pairs. Reference may be made to FIG. 12. In this way, an obtained round-trip movement path can accurately cover the entire workable area.

Further, a corresponding drive circuit instruction may be generated based on the round-trip movement path. The drive circuit instruction is performed, so that the self-moving device can be precisely controlled to start from the reference point and move along the round-trip movement path, to complete the movement that can cover the entire workable area.

In an embodiment, in the process of performing the drive circuit instruction to control the self-moving device to move along the round-trip movement path, specific work may also be performed according to a specific work task. For example, the self-moving lawn treatment device may perform mowing processing in the process of moving along the round-trip movement path. In this way, after completing the round-trip movement covering the lawn, mowing work on the lawn is also completed.

In an embodiment, the movement path may be alternatively annular paths that gradually shrink toward the center of annular path area or annular paths that gradually expand from the center of an area toward a boundary, for example, annular paths that gradually expand from a house toward a lawn boundary (not shown in the figure). In an embodiment, the movement path may be alternatively a random path.

During specific implementation, the user may select one or more of the movement paths as cutting modes or the system may automatically generate a cutting mode according to a feature, for example, the shape, of an area.

In an embodiment, a pattern may be cut on a lawn through a path.

In an embodiment, the workable area in which the self-moving device needs to work includes a plurality of sub-areas. For example, the workable area includes two sub-areas. Correspondingly, a plurality of reference points are determined. There is at least one reference point in every sub-area. For the foregoing scenario, after completing work in one sub-area, the self-moving device needs to move from the current sub-area to a next sub-area, to perform work for the next sub-area.

In this case, a second movement path may be generated. The second movement path may be a movement path for instructing the second movement path to move from the current sub-area to a reference point in the next sub-area. Specifically, the second movement path may pass through a passable non-working area and/or a workable area.

Correspondingly, a second drive circuit instruction is generated. After receiving the second drive circuit instruction, the self-moving device may perform the second drive circuit instruction based on the coordinate information (which may be determined by the navigator of the self-moving device) of the current position, so that the self-moving device can be accurately controlled to move from the current sub-area to the next sub-area along the second movement path through a workable area and/or a passable non-working area, to perform work for the next sub-area.

In an embodiment, the self-moving device moves to a reference point, walks one lap along a boundary through vision, updates the coordinates of the boundary in the process or after movement along the boundary, making the boundary more precise, and then starts subsequent work.

In an embodiment, the self-moving device moves to a reference point, first walks along the boundary through vision and performs cutting, and uses robotic operating system (ROS) proportional-integral-derivative (PID) control to implement walking along the boundary. Next, a cutting mark is recognized, and the cutting mark is converted into a line. The self-moving device moves along the line and performs cutting, offsetting approximately the width of one device body. The foregoing process is repeated until cutting is completed in the area, and the self-moving device then moves into a next area.

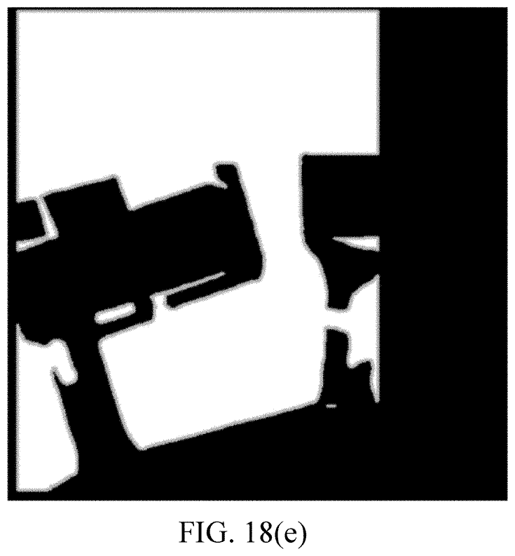

The movement path is shown in FIG. 16(a) or FIG. 16(b).

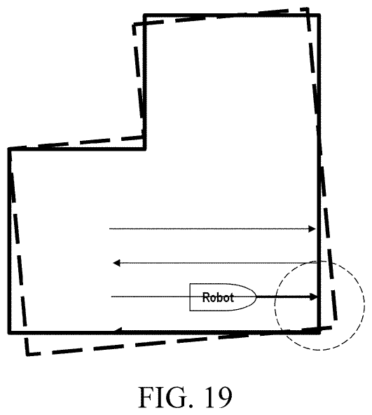

In the foregoing embodiments, a movement control procedure is shown in FIG. 17.

In an embodiment, if a work task that the self-moving device needs to perform is a more precise workable area boundary determined through on-site measurement, correspondingly, the reference point may be a point in a target range area between adjacent workable area boundary lines of the workable area. After moving to a reference point or an adjacent range area of a reference point, the self-moving device may visually recognize a workable area boundary in an actual environment. Further, a corresponding movement path may be generated according to the recognized workable area boundary in the actual environment. For example, the movement path may be alternatively a third movement path along the workable area boundary. A third drive circuit instruction is generated based on the third movement path. The third drive circuit instruction may be performed based on the coordinate information of a reference point, to control the self-moving device to move along the visually recognized workable area boundary in the actual environment, and continuously calibrate the third movement path during movement according to the visually recognized workable area boundary in the actual environment, so as to prevent the self-moving device from moving to an area outside the workable area boundary and control the self-moving device to move and work within the workable area range.

Further, the workable area boundary in the semantic map may be corrected based on the workable area boundary obtained from the actual environment.

In an embodiment, a more precise working area map for a target working area may further be generated according to the coordinate information recorded during the moment along the workable area boundary in the actual environment. Subsequently, the self-moving device may move in the target working area according to the working area map to perform corresponding work.

In an embodiment, the working area map is obtained through the integration of vision, an encoder, and an inertial measurement unit (IMU).

In an embodiment, perspective transformation is performed on an image captured by a camera to transform a camera coordinate into a world coordinate, to obtain the working area map.

In an embodiment, specifically, for example, a 360-degree rotatable camera is configured and mounted on the self-moving lawn treatment device. Reference may be made to FIG. 3. During specific implementation, the self-moving lawn treatment device may use a reference point as a start point, first choose a preset initial direction (for example, east) as a start direction, rotate the camera by every preset interval angle (for example, every 5 degrees) in a preset rotational direction (for example, the counterclockwise direction) to obtain an environmental picture including a surrounding environment, and at the same time record an angle between the direction of photographing the environmental picture by the camera and the start direction. Further, the processor may perform processing and recognition on the obtained environmental picture to find a boundary position between a lawn and a surrounding area in the environment. For example, a central position between a green block and another color in the picture may be found through color recognition and used as the boundary position. Distances between boundary positions and a reference point in the environmental pictures according to a particular proportion. Further, a boundary contour surrounding the lawn may be determined according to the distances between the boundary positions and the reference point, angles between directions of photographing the environmental pictures at the boundary positions and the start direction, and the reference point. Next, a walking path starting from the reference point may be determined by using the reference point as the origin and according to the boundary contour.

In this embodiment, to ensure that the determined lawn boundary has high precision and small errors, the self-moving lawn treatment device may use the walking path determined based on the boundary contour as guidance, first moves to a corresponding position, and then performs detection and calibration at the position, to ensure that the position is a boundary. After the calibration, coordinate information of the current position may further be obtained by using the navigator. After obtaining the coordinate information of the current position, further, the self-moving lawn treatment device may move to a next position along the lawn boundary according to the walking path, and the foregoing operations are repeated. After the self-moving lawn treatment device sequentially records the coordinate information during movement, the lawn boundary is determined.

In this embodiment, during specific implementation, the self-moving lawn treatment device moves to the determined boundary contour according to the foregoing walking path. A ground image obtained at the position is then acquired to determine whether the position is an actual lawn boundary. If it is determined that the position is an actual lawn boundary, the coordinate information (for example, the latitude and longitude coordinates of the current position point) of the current position may be recorded, to further determine coordinate information of a point on the lawn boundary.

In this embodiment, during specific implementation, according to a specific case and a processing requirement, the actual lawn boundary may be alternatively determined in another manner.

Specifically, for example, after the reference point is determined according to target image data, the processor may further determine, from the target image data in a manner such as image recognition, a contour line surrounding the target lawn, and then generate, according to the contour line and the reference point, a walking path with the reference point as the start point. The self-moving lawn treatment device may further move along the lawn boundary according to the walking path, and continuously adjust a current position point during movement, to ensure that the self-moving lawn treatment device moves along the lawn boundary, so that coordinate information of points on an actual lawn boundary may be obtained by recording the coordinate information during movement.

In another example, a lawn boundary is usually formed by straight lines. In a case that the reference point includes an intersection between two adjacent boundary lines on the lawn boundary, an inertial navigation system is further configured and installed in advance on the self-moving lawn treatment device. After reaching the reference point through navigation, the self-moving lawn treatment device may first choose a straight line along a boundary line 1 as a first path, which may be marked as S1. Further, the self-moving lawn treatment device may move along the first path S1 to a next intersection, that is, an intersection between boundary lines 2 and 3, by using the inertial navigation system. During movement, the self-moving lawn treatment device may use the navigator to obtain coordinate information of points on the passed boundary line 2, so as to obtain coordinate information of points on the boundary line 1 of the lawn. After the self-moving lawn treatment device reaches the intersection between the boundary lines 2 and 3, the foregoing manner may be repeated to choose a straight line along the boundary line 3 as a second path, which is marked as S2. The self-moving lawn treatment device may further move along the second path S2 by using the inertial navigation system, and obtain recorded coordinate information of points on the passed boundary line 3. In the foregoing manner, the self-moving lawn treatment device may automatically move past boundary lines surrounding the target lawn, and obtain coordinates of points on the boundary lines, to determine the lawn boundary of the target lawn.

In this embodiment, after the lawn boundary of the target lawn is determined, the user may input a mowing instruction by using the client device. After receiving the mowing instruction sent by the client device, the self-moving lawn treatment device may respond to the mowing instruction to generate, according to the determined target boundary, a mowing path that covers the target lawn and does not exceed the lawn boundary. The self-moving lawn treatment device may move and perform mowing on the target lawn according to the mowing path. During mowing, the self-moving lawn treatment device may further specifically obtain coordinate information of a current position point of the self-moving lawn treatment device by using the navigator, and compares the coordinate information of the current position point with coordinate information of a point on the determined lawn boundary, to determine whether the current position point of the self-moving lawn treatment device is a point in an area outside the lawn boundary. If it is determined that the current position point is a point in an area outside the lawn boundary, it may be determined that the lawn robot has left a range area of the target lawn. In this case, to ensure safety, the self-moving lawn treatment device may stop mowing. Further, the self-moving lawn treatment device may search for a reference point by using the navigator and move to the reference point, to return to a range area of the target lawn. In an embodiment, after recognizing the workable area boundary through visual recognition, the self-moving device further generates a third drive circuit instruction instructing to steer away from a working area boundary.

After receiving the third drive circuit instruction, the self-moving device may perform the third drive circuit instruction, to control the self-moving device to steer along the third movement path to move away from the working area boundary. Therefore, the self-moving device can be prevented from moving to a non-working area outside the workable area boundary, to ensure that the self-moving device moves and works in the workable area.

In an embodiment, during specific implementation, the client device, the processor of the self-moving device or the cloud server may generate a corresponding movement path in the foregoing manner according to a specific scenario and a processing requirement.

In an embodiment, when moving along the movement path, the self-moving device may further determine, through visual recognition, whether there is an obstacle at a position at a preset distance in front of a current position. The obstacle may be specifically a human, an animal, a rockery, a building or the like. An adjusted path may be generated in time if it is determined that there is an obstacle at the position at the preset distance in front of the current position. The adjusted path includes a movement path bypassing the obstacle. The self-moving device may be controlled to move along the adjusted path to avoid an obstacle to move smoothly. In an embodiment, an obstacle is recognized and avoided based on semantic segmentation.

In an embodiment, objects recognized by using the preset recognition model are classified and labels are assigned, and actions of the self-moving device are correspondingly set to implement navigation. The classes may be recognized in the semantic map or may be visually recognized during the movement of the self-moving device.

One of the classes is used to recognize a specific object, to enable the self-moving device to perform a specific action. The specific object includes a human, an animal, a garage, a garage door or the like. For example, when recognizing an owner or a pet, the self-moving device avoids a movement area of the owner or pet to avoid cutting injury. When recognizing a stranger or wild animal, the self-moving device sends a signal to drive away the stranger or wild animal. In still another example, when recognizing a garage or garage door, the self-moving device controls the garage door to open automatically to enter the garage.

Another class may be used to control the working, including walking and/or cutting, of the self-moving device. Examples are shown in the following table.

| Label | Examples of objects | Action |
|---|---|---|
| Sidewalk | Concrete/Asphalt sidewalk | Not walking |
| Excessively-high | Flowerbed, bush, weeds | Not cutting |
| objects | | |
| Tree | Tree, trunk | Not cutting |
| Passable landform | Sawdust, soil | Walking |
| Passable landform | Wall, fence, building, air | Not walking |
| | conditioning unit, rock, | |
| | pebbles, sand | |
| Water | Pond | Not walking |

In an embodiment, a specific movement path is formed based on the reference point. A positioning signal may be specifically obtained, and the positioning signal is integrated to generate the specific movement path.

In an embodiment, the positioning signal may be specifically from inertial navigation, a speedometer or satellite navigation. Certainly, the sources of a positioning signal listed above are only examples of description. During specific implementation, according to a specific application scenario, the positioning signal may be alternatively from another positioning device. This is not limited in this specification.

By means of the path forming method for a self-moving device provided in this embodiment of this specification, a preset recognition model is invoked, and electronic map data that is obtained from an electronic map database and includes image data of a target working area correlated to coordinate information is recognized and processed, to obtain a semantic map that includes an automatically recognized workable area and/or workable area boundary. A corresponding reference point may be marked in the semantic map or electronic map data, and a movement path of the self-moving device is then generated based on the reference point. Therefore, a user does not need to guide a self-moving device in advance to move around a target working area, and the self-moving device can automatically generate a corresponding movement path according to a specific service task, so that the operations of the user are simplified, the use experience of the user is improved, and the efficiency of generating a movement path for a self-moving device is improved, thereby resolving the technical problems of low efficiency of generating a movement path, complex operations of the user, and poor use experience in existing methods.

In an embodiment, the preset recognition model may be a processing model obtained in advance through training in a manner such as deep learning.

During specific implementation, a plurality of pieces of electronic map data including a target working area may be obtained and used as sample data. The electronic map data is then marked, to mark range areas of a workable area and/or workable area boundary in image data of the electronic map data. Therefore, marked sample data is obtained. Further, a neural network model or another type of model used for processing the image data may be established and used as an initial model. The marked sample data is then used as model training data. The marked sample data is used for performing learning and training on the initial model, so as to continuously adjust or change model parameters in the initial model. When an error rate in the recognition of electronic map data based on the model with the adjusted model parameters is less than a preset error rate threshold, the adjusted model parameters currently used in the model are determined as the model parameters of the preset recognition model, thereby obtaining a preset recognition model with relatively high accuracy.

The initial model may specifically include a CNN model or the like.

Certainly, the manner of obtaining a preset recognition model listed above is only an example of description. During specific implementation, in addition to deep learning, another manner of learning and training may further be used to perform model training, to obtain a preset lawn recognition model satisfying a requirement. For example, acquired sample data may be alternatively not marked. An unsupervised-learning algorithm or a reinforcement learning algorithm is used to perform learning on the sample data, to obtain a corresponding preset recognition model.

In an embodiment, the workable area specifically includes at least two separated sub-areas. Correspondingly, at least two reference points are marked on the semantic map. Each reference point corresponds to one sub-area. Every sub-area includes at least one reference point.

In this embodiment, the target working area is sometimes relatively complex. For example, one large workable area may include two or more separated sub-areas.

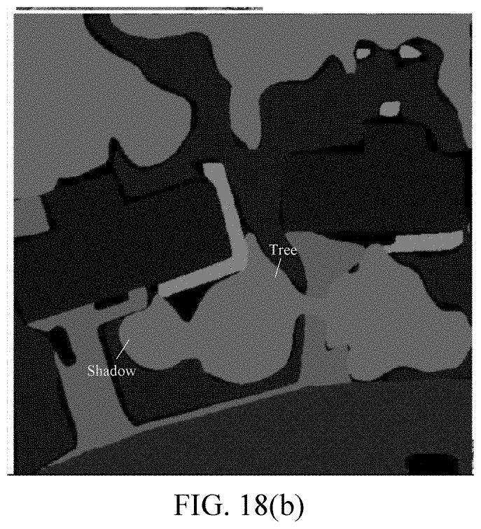

Reference may be made to FIG. 13. The target working area in which the self-moving device needs to work may specifically include five different sub-areas, namely, a sub-area 1, a sub-area 2, a sub-area 3, a sub-area 4, and a sub-area 5. Corridors in which the self-moving device may freely pass but is not allowed to work, that is, passable non-working areas, are provided between the sub-area 1 and the sub-area 2, between the sub-area 2 and the sub-area 3, between the sub-area 4 and the sub-area 5, and between the sub-area 2 and the sub-area 4. A wall, that is, an impassable non-working area, is provided between the sub-area 3 and the sub-area 4. According to an instruction of the user, the self-moving device may sequentially complete service work in the sub-areas.

Based on the method provided in this embodiment, reference points may be first marked on the semantic map. A reference point 1 is marked in the sub-area 1. A reference point 2 is marked in the sub-area 2. A reference point 3 is marked in the sub-area 3. A reference point 4 is marked in the sub-area 4. A reference point 5 is marked in the sub-area 5. A reference point 6 is marked in a passable non-working area between the sub-area 1 and the sub-area 2. A reference point 7 is marked in a passable non-working area between the sub-area 2 and the sub-area 3. A reference point 8 is marked in a passable non-working area between the sub-area 4 and the sub-area 5. A reference point 9 is marked in a passable non-working area between the sub-area 2 and the sub-area 4.

In this embodiment, during specific implementation, the self-moving device may first use the reference point 1 in the sub-area 1 as the start point, and after service work in the sub-area 1 is completed, generate a cross-area movement path by using a point at a position with reference to service work in the sub-area 1 is completed as the start point and using the reference point 2 in the sub-area 2 as an end point. Further, the self-moving device may move from the sub-area 1 to the reference point 2 in the sub-area 2 according to the cross-area movement path. The reference point 2 is then used as the start point to complete service work in the sub-area 2. As deduced by analogy, the self-moving device may sequentially complete service work in the sub-areas in the target working area.

In another embodiment, during specific implementation, after completing service work in the sub-area 1, the self-moving device may first return to the reference point 1, and then move from the sub-area 1 to the sub-area 2 according to a movement path that passes through the reference point 1, the reference point 6, and the reference point 2 to perform service work in the sub-area 2. After completing service work in the sub-area 2, the self-moving device first returns to the reference point 2, and then moves from the sub-area 2 to the sub-area 3 according to a movement path that passes through the reference point 2, the reference point 7, and the reference point 3 to perform service work in the sub-area 3. After completing service work in the sub-area 3, an impassable non-working area is provided between the sub-area 3 and the sub-area 4. Therefore, the self-moving device cannot directly move from the sub-area 2 to the sub-area 3. In this case, after returning to the reference point 3, the self-moving device may first return from the sub-area 3 to the sub-area 2 according to a movement path that passes through the reference point 3, the reference point 7, and the reference point 2; and then further move from the sub-area 2 to the sub-area 4 through a movement path that passes through the reference point 2, the reference point 9, and the reference point 4. In this way, the self-moving device may successfully enter the sub-area 4 and perform specific service work in the sub-area 4. After completing service work in the sub-area 4, the self-moving device may return to the reference point 4, and then move from the sub-area 4 to enter the sub-area 5 according to a movement path that passes through the reference point 4, the reference point 8, and the reference point 5 to perform service work in the sub-area 5. In the foregoing manner, the self-moving device may sequentially move, according to the instruction of the user in a sequence number order of sub-areas, to the sub-areas to complete service work in the sub-areas.

The self-moving device needs to sequentially move into the sub-areas to perform work. After completing work in the sub-areas, the work in the workable area is eventually completed.

In an embodiment, when the work in a current sub-area is completed, a movement path for movement to a next sub-area needs to be generated, so that the self-moving device may further be controlled to move from the current sub-area to the next sub-area along the movement path to perform work in the next sub-area.

In an embodiment, during specific implementation, the forming a movement path based on the reference point may further include the following content: generating a second drive circuit instruction, where the second drive circuit instruction instructs to move, after movement path is completed in a corresponding sub-area based on one of the reference points, to a reference point corresponding to another sub-area to start movement in the another sub-area.

In an embodiment, the semantic map may further specifically include a recognized passable non-working area and/or passable non-working area boundary, and the passable non-working area and/or passable non-working area boundary is correlated to the coordinate information. The passable non-working area may specifically include an area that allows the self-moving device to move and pass in the non-working area.

Correspondingly, during specific implementation, the moving, after movement is completed in a corresponding sub-area based on one of the reference points, to a reference point corresponding to another sub-area may include the following content: moving, after movement is completed in the corresponding sub-area based on one of the reference points, to the reference point corresponding to the another sub-area through the passable non-working area.

In an embodiment, during specific implementation, the marking at least one reference point on the semantic map or the electronic map data may include the following content: automatically determining a point in the target working area as the reference point according to the semantic map.

In an embodiment, the automatically determining a point in the target working area as the reference point according to the semantic map includes: automatically determining a corner point of the workable area and/or a turning point of the workable area boundary as the reference point.

In an embodiment, during specific implementation, the marking at least one reference point on the semantic map or the electronic map data may include: presenting the semantic map or the electronic map data to a user; receiving a selection operation of the user on the semantic map or the electronic map data; and marking the reference point on the semantic map or the electronic map data according to the selection operation.

In an embodiment, during specific implementation, the forming a movement path based on the reference point may include: generating a first drive circuit instruction, where the first drive circuit instruction instructs to move to the reference point or an adjacent range area of the reference point; and executing, by the self-moving device, the first drive circuit instruction by performing positioning and based on coordinate information of the reference point.

In an embodiment, after the drive circuit instruction is executed based on the coordinate information of the reference point, the method may further specifically include:

forming a new movement path by using the reference point as the start point.

In an embodiment, during specific implementation, the method may further include: recognizing the workable area boundary through visual recognition; and generating a third drive circuit instruction based on the recognized boundary, where the third drive circuit instruction instructs to move along the workable area boundary and/or steer to move away from the workable area boundary.

In an embodiment, during specific implementation, the method may further include: recognizing the workable area boundary through visual recognition; operating the self-moving device to move along the workable area boundary, and recording the coordinate information in a movement process through positioning; and generating a working area map of the target working area according to the recorded coordinate information.

In an embodiment, during specific implementation, the forming a movement path based on the reference point includes: generating a round-trip movement path based on the reference point, where the round-trip movement path includes a former path section and a latter path section, and the latter path section is offset from the former path section by a preset distance.

In an embodiment, during specific implementation, the forming a movement path based on the reference point may include: determining, through visual recognition, whether there is an obstacle at a position at a preset distance in front of a current position; and generating an adjusted path if it is determined that there is an obstacle at the position at the preset distance in front of the current position, where the adjusted path is used for avoiding the obstacle.

In an embodiment, during specific implementation, the forming a movement path based on the reference point may include: generating the movement path based on the integration of a positioning signal, where the positioning signal is obtained from inertial navigation, a speedometer or satellite navigation.

In an embodiment, the electronic map database may specifically include an online satellite map database. Certainly, the electronic map database listed above is only an example of description. During specific implementation, another electronic map database may be used according to a specific application scenario. This is not limited in this specification.

In an embodiment, during specific implementation, the invoking a preset recognition model, and determining a semantic map based on the electronic map data may include: performing convolution processing on the image data in the electronic map data by using a trained neural network model, to obtain the semantic map.

In an embodiment, the self-moving device may specifically include a self-moving lawn treatment device, and correspondingly, the target working area may specifically include a to-be-mowed target lawn. The self-moving device may specifically include a self-moving monitoring robot, and correspondingly, the target working area may specifically include a range area in which the self-moving monitoring robot needs to perform monitoring and management. Certainly, the self-moving device and the target working area listed above are only examples of description. During specific implementation, according to a specific application scenario, the self-moving device may alternatively include another type of device, and correspondingly, the target working area may alternatively include another type of area. This is not limited in this specification.

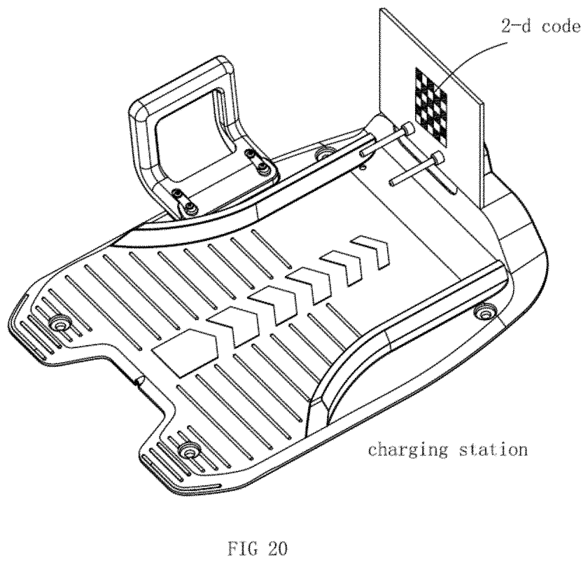

FIG. 18(a) to FIG. 18(e) are schematic diagrams of the division of a movement area according to an embodiment of this specification. In this embodiment, Google Map is used to define boundaries to obtain an initial map. As shown in FIG. 18(a), electronic map data, for example, Google Map data, is first obtained. Based on the electronic map data, deep learning is performed by using a neural network model to determine a semantic map, as shown in FIG. 18(b). A possible working area is recognized by using the semantic map. In the map shown in FIG. 18(b), a tree and a shadow are segmented through semantic segmentation. In this embodiment, the tree and the shadow are considered as a workable area, to obtain a map shown in FIG. 18(c). As shown in FIG. 18(d), a boundary is extracted. As described above, a position with an unclear boundary may be manually defined. Finally, as shown in FIG. 18(e), an initial map in a world coordinate system is obtained for use of navigation of the self-moving device.

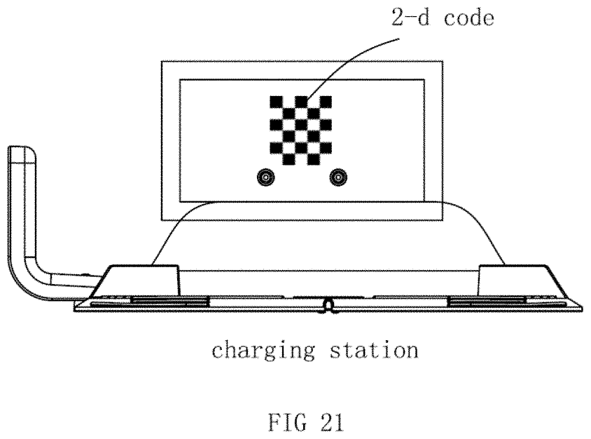

FIG. 19 is a schematic diagram of a boundary correction process according to an embodiment of this specification. After the initial boundary is obtained, the self-moving device walks one lap along the boundary through vision and recognizes the boundary through vision. During walking, position information is obtained by using the initial position and inertial navigation, to establish the boundary. The initial boundary is compared with the boundary established through walking to correct the boundary. For example, the boundary is corrected by using corner overlapping. In an embodiment, as the self-moving device traverses the working area, the boundary is visually recognized during steering, and is corrected. As shown in FIG. 19, when the self-moving device walks near the boundary but has not reached the initial boundary (shown by the dashed line in the figure), the self-moving device visually recognizes the actual boundary (shown by the solid line in the figure), to determine a new boundary position. The self-moving device steers and records the actual boundary position, and uses the actual boundary position to correct the initial map, to obtain the corrected map.

As can be seen from above, by means of the path forming method for a self-moving device provided in this embodiment of this specification, a preset recognition model is invoked, and electronic map data that is obtained from an electronic map database and includes image data of a target working area correlated to coordinate information is recognized and processed, to obtain a semantic map that includes an automatically recognized workable area and/or workable area boundary. A corresponding reference point may be marked in the semantic map or electronic map data, and a movement path of the self-moving device is then generated based on the reference point. Therefore, a user does not need to guide a self-moving device in advance to move around a target working area, and the self-moving device can automatically generate a corresponding movement path according to a specific service task, so that the operations of the user are simplified, the use experience of the user is improved, and the efficiency of generating a movement path for a self-moving device is improved, thereby resolving the technical problems of low efficiency of generating a movement path, complex operations of the user, and poor use experience in existing methods. Further, during the movement in the workable area based on the generated movement path, it is detected in real time through visual recognition whether there is an obstacle at a preset distance in front of the self-moving device. When an obstacle is detected, the executed movement path is adjusted in real time, and the self-moving device then moves according to the adjusted movement path, so that the obstacle can be intelligently found and avoided, to ensure the safe movement of the self-moving device. Further, an actual workable area boundary is detected based on visual recognition, and the movement path is then adjusted according to the recognized actual workable area boundary, so that the self-moving device can move and work within the workable area boundary more precisely based on the adjusted movement path, to prevent the self-moving device from moving beyond the workable area boundary.

An embodiment of this specification further provides a self-moving lawn treatment device. Specifically, referring to FIG. 3, the self-moving lawn treatment device may include at least component devices such as a processor, a signal transceiver, and a navigator. The signal transceiver may be specifically configured to obtain image data including a target lawn and electronic map data with correlated coordinate information. The processor may be specifically configured to: invoke a preset recognition model, and determine a semantic map based on the electronic map data, where the semantic map includes a recognized workable area and/or workable area boundary, and the workable area and/or workable area boundary is correlated to the coordinate information; mark at least one reference point on the semantic map or the electronic map data; and form a movement path based on the reference point.

In this embodiment, the self-moving lawn treatment device further includes a movement component and a cutting component. The movement component may be configured to move the self-moving lawn treatment device. The cutting component may be configured to perform specific mowing work.

Certainly, the component structures listed above are only examples of description. During specific implementation, other component structures in addition to the component structures listed above may further be introduced according to a specific application scenario and working requirement to form the self-moving lawn treatment device. For example, some self-moving lawn treatment devices may further include a posture detector, a laser rangefinder, a direction sensor, a camera, and the like.

In this embodiment, the navigator may specifically include a GPS antenna or the like. In this way, the navigator receives coordinate information of a position point.

In an embodiment, the processor may further be specifically configured to control the self-moving lawn treatment device to move within the boundary of the target lawn along the movement path and perform cutting work.

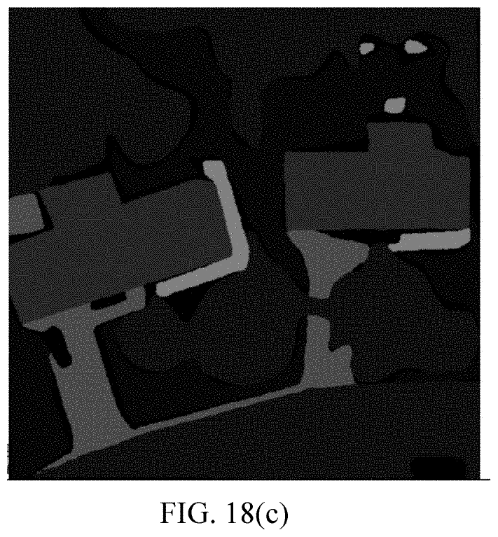

Referring to FIG. 14, on the software level, an embodiment of this specification further provides an apparatus for determining a lawn boundary. The apparatus may specifically include the following structural modules.

An obtaining module 1401 may be specifically configured to obtain electronic map data from an electronic map database, where the electronic map data includes image data including a target working area, and the image data is correlated to the coordinate information.

A recognition module 1402 may be specifically configured to: invoke a preset recognition model, and determine a semantic map based on the electronic map data, where the semantic map includes a recognized workable area and/or workable area boundary, and the workable area and/or workable area boundary is correlated to the coordinate information;

A marking module 1403 may be specifically configured to mark at least one reference point on the semantic map or the electronic map data.

A movement path forming module 1404 may be specifically configured to form a movement path based on the reference point.

In an embodiment, target image data may specifically include satellite map data or the like including a target lawn.

It should be noted that the units, apparatuses or modules described in the foregoing embodiments may be specifically implemented by a computer chip or an entity or is implemented by a product having a function. For ease of description, when the foregoing system is described, the apparatus includes modules according to functions, which are separately described. Certainly, during the implementation of this specification, the functions of the modules may be implemented in one or more pieces of software and/or hardware, the modules for implementing the same function may be implemented by a combination of a plurality of submodules or subunits or the like. The described apparatus embodiment is merely exemplary. For example, the unit division is merely logical function division and may be other division during actual implementation. For example, multiple units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic or other forms.

By means of the path forming apparatus for a self-moving device provided in this embodiment of this specification, the recognition module invokes a preset recognition model, and recognizes and processes electronic map data that is obtained by the obtaining module from an electronic map database and includes image data of a target working area correlated to coordinate information, to obtain a semantic map that includes a recognized workable area and/or workable area boundary. The marking module may mark a corresponding reference point in the semantic map, and the movement path forming module then generates a movement path of the self-moving device based on the reference point. Therefore, a user does not need to guide a self-moving device in advance to move around a target working area, and the self-moving device can automatically generate a corresponding movement path according to a specific service task, so that the operations of the user are simplified, the use experience of the user is improved, and the efficiency of generating a movement path for a self-moving device is improved, thereby resolving the technical problems of low efficiency of generating a movement path, complex operations of the user, and poor use experience in existing methods.

An embodiment of this specification further provides a client device, including: a processor; and a memory, storing processor-executable instructions, where during specific implementation, the processor may perform the following steps according to the instructions: obtaining electronic map data from an electronic map database, where the electronic map data includes image data including a target working area, and the image data is correlated to coordinate information; invoking a preset recognition model, and determining a semantic map based on the electronic map data, where the semantic map includes a recognized workable area and/or workable area boundary, and the workable area and/or workable area boundary is correlated to the coordinate information; marking at least one reference point on the semantic map or the electronic map data; and forming a movement path based on the reference point. Therefore, according to the movement path, the self-moving device moves in the target working area along the movement path through navigation, to perform corresponding work.

In this embodiment, the client device may specifically include a front-end device that is applied to a user side and can implement functions such as data input and data transmission. Specifically, the client device may be, for example, a desktop computer, a tablet computer, a notebook computer, a smart phone or a remote control. Alternatively, the client device may be a software application that can be run in an electronic device. For example, the client device may be an APP run on a mobile phone.

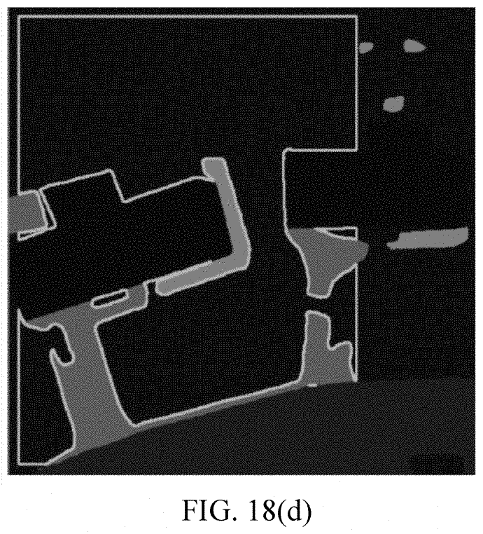

To accomplish the foregoing instructions more accurately, referring to FIG. 15, an embodiment of this specification further provides a path forming apparatus for a self-moving device. A client device includes a memory 1501 and a processor 1502. The structures are connected by an internal cable, so that the structures may perform specific data exchange.

The memory 1501 may be specifically configured to store computer-readable instructions.

The processor 1502 may be specifically configured to perform, when executing the computer-readable instructions, the following steps: obtaining electronic map data from an electronic map database, where the electronic map data includes image data including a target working area, and the image data is correlated to coordinate information; invoking a preset recognition model, and determining a semantic map based on the electronic map data, where the semantic map includes a recognized workable area and/or workable area boundary, and the workable area and/or workable area boundary is correlated to the coordinate information; marking at least one reference point on the semantic map or the electronic map data; and forming a movement path based on the reference point.

In this embodiment, the processor 1501 may be implemented in any suitable manner. For example, the processor may be a microprocessor or a processor, and a computer-readable medium, a logic gate, a switch, an application-specific integrated circuit (ASIC), a programmable logic controller, and an embedded microcontroller stores a computer-readable program code (for example, software or firmware) executable by the (micro)processor. This is not limited in this specification.

In this embodiment, the memory 1502 may include a plurality of levels. Any memory can be used provided that the memory can store binary data in a digital system. A circuit that is not in a physical form and has a storage function may also be referred to as a memory such as a random access memory (RAM) and a First In, First Out (FIFO) in an integrated circuit. In the system, a storage device in a physical form is also referred to as a memory, for example, a RAM, a TransFlash (TF) card.

An embodiment of this specification further provides an automatic working system, including a self-moving device and an application installed on a user terminal side, where the application includes: an obtaining procedure, including: obtaining electronic map data from an electronic map database, where the electronic map data includes image data including a target working area, and the image data is correlated to coordinate information; a recognition procedure, including: invoking a preset recognition model, and determining a semantic map based on the electronic map data, where the semantic map includes a recognized workable area and/or workable area boundary, and the workable area and/or workable area boundary is correlated to the coordinate information; and a marking procedure, including: marking at least one reference point on the semantic map or the electronic map data; the self-moving device includes a communication module, communicating with a client, and obtaining coordinate information of the reference point from the client after the application is executed; and the self-moving device further includes a positioning module, forming a movement path by monitoring an output of the positioning module and based on the coordinate information of the reference point.

An embodiment of this specification further provides an automatic working system, including: a self-moving device, where the self-moving device includes a housing, a movement module mounted at the housing, and a control module controlling the movement module to drive the self-moving device to move; the self-moving device further includes a positioning module, configured to output coordinate information of the self-moving device; the automatic working system further includes a storage unit, storing: a semantic map generation procedure, including: obtaining electronic map data from an electronic map database, where the electronic map data includes image data including a target working area, and the image data is correlated to the coordinate information; invoking a preset recognition model, and determining a semantic map based on the electronic map data, where the semantic map includes a recognized workable area and/or workable area boundary, and the workable area and/or workable area boundary is correlated to the coordinate information; and a marking procedure, including: marking at least one reference point on the semantic map or the electronic map data; the automatic working system executes the semantic map generation procedure and the marking procedure, to determine coordinate information of the reference point; and the control module controls the movement module by monitoring an output of the positioning module and based on the coordinate information of the reference point to form a movement path.

An embodiment of this specification further provides a computer-readable storage medium based on the path forming method for a self-moving device, the computer-readable storage medium storing computer program instructions, the computer program instructions, when being implemented, implementing the following steps: obtaining electronic map data from an electronic map database, where the electronic map data includes image data including a target working area, and the image data is correlated to coordinate information;

invoking a preset recognition model, and determining a semantic map based on the electronic map data, where the semantic map includes a recognized workable area and/or workable area boundary, and the workable area and/or workable area boundary is correlated to the coordinate information; marking at least one reference point on the semantic map or the electronic map data; and forming a movement path based on the reference point.

An embodiment of this specification further provides a solution of returning to a docking station based on machine vision. Specifically, as shown in FIG. 20 and FIG. 21, for example, the self-moving lawn treatment device is equipped with a camera and a charging terminal arranged in a forward or backward movement direction of the device. A charging station for the self-moving lawn treatment device is provided with an image label, which is, for example, a 2-d code image, such as a barcode or a quick response (QR) code. The self-moving lawn treatment device uses the camera to capture a continuous image flow of the barcode, the QR code, or other image labels to implement alignment in six degrees of freedom (6DOF), thereby achieving precise docking. Specifically, for example, the self-moving lawn treatment device continuously determines, according to shapes and sizes of feature points of the image of the barcode or the QR code, a relationship between the device and the charging station in the six degrees of freedom, and continuously adjusts its coordinates and orientation according to the determination result, so as to approach the charging station and implement the precise docking of the charging terminal of the device to a charging terminal of the charging station.

In this embodiment, the storage medium includes, but is not limited to, a RAM, a read-only memory (ROM), a cache, a hard disk drive (HDD) or a memory card. The storage medium may be configured to store the computer program instructions. A network communication unit may be an interface that is set according to standards specified in communication protocols and configured to perform network connection communication.

In this embodiment, the functions and effects specifically implemented by computer instructions stored in the computer storage medium may be compared with other implementations for description. Details are not described herein again.

Although this specification provides the operation steps in the methods in the embodiments or flowcharts, more or fewer operation steps may be included based on conventional or noncreative measures. The step order listed in the embodiments is merely one manner in various step execution orders but does not represent the only execution order. The execution by the apparatuses or client products in practice may be execution in the method order shown in the embodiments or accompanying drawings or parallel execution (for example, an environment of a parallel processor or multi-thread processing or an environment of distributed data processing). The terms “comprise”, “include”, and any variants thereof are intended to cover a non-exclusive inclusion. Therefore, in the context of a process, method, product or device that includes a series of elements, the process, method, product or device not only includes such elements, but also includes other elements not specified expressly, or may include inherent elements of the process, method, product or device. Unless otherwise specified, other same or equivalent elements existing in the process, method, product or apparatus that includes the element are not excluded. The terms such as “first” and “second” are used to represent names but are not used to represent any specific order.

Those skilled in the art also know that the controller may be implemented purely by computer-readable program code, and the steps in the method may also be logically programmed to enable the controller to implement the same functions in the form of logic gates, switches, ASICs, programmable logic controllers, and embedded microcontrollers. Therefore, the controller may be considered as a hardware component, and the apparatuses that are included in the controller and configured to implement various functions may also be considered as structures in the hardware component. Alternatively, the apparatuses for implementing various functions may even be considered as both software modules for implementing the method and structures in the hardware component.

This specification may be described in the general context, for example, program modules, of the computer-executable instructions executed by the computer. Generally, the program modules include routines, programs, objects, components, data structures, classes, and the like for implementing specific tasks or implementing specific abstract data types. This specification may be alternatively practiced in distributed computing environments. In these distributed computing environments, remote processing devices connected by communication networks perform tasks. In the distributed computing environments, the program modules may be located in a local or remote computer storage medium including a storage device.

As can be seen from the description of the foregoing embodiments, a person skilled in the art may clearly understand that this specification may be implemented by software plus a necessary universal hardware platform. Based on such an understanding, the technical solutions of this specification essentially may be implemented in the form of a software product. The computer software product may be stored in a storage medium such as a ROM/RAM, a magnetic disk or an optical disc, and includes several instructions for instructing a computer device (which may be a personal computer, a mobile terminal, a server, a network device or the like) to perform the methods in the embodiments of this specification or some parts of the embodiments.

The embodiments in this specification are all described in a progressive manner, for same or similar parts in the embodiments, refer to these embodiments, and descriptions of each embodiment focus on differences from other embodiments. This specification may be used in various general-purpose or special-purpose computer system environments or configurations, for example, a personal computer, a server computer, a handheld device or portable device, a tablet device, a multi-processor system, a microprocessor-based system, a set-top box, a programmable electronic device, a network personal computer (PC), a small-scale computer, a large-scale computer or a distributed computing environment including any system or device in the foregoing.

Although this specification is described through embodiments, a person skilled in the art knows that many variations or changes may be made to this specification without departing from the spirit of this specification, and these variations and changes are intended to fall within the appended claims without departing from the spirit of this specification.

What is claimed is:

1. An area division and path forming method for a self-moving device, comprising:
obtaining electronic map data from an electronic map database, wherein the electronic map data comprises image data comprising a target working area, and the image data is correlated to coordinate information;
invoking a preset recognition model, and determining a semantic map based on the electronic map data, wherein the semantic map comprises a recognized workable area and/or workable area boundary, and the workable area and/or workable area boundary is correlated to the coordinate information;
marking at least one reference point on the semantic map or the electronic map data; and
forming a movement path by using the reference point as a start point and based on the workable area and/or workable area boundary on the semantic map.

2. The method according to claim 1, wherein the marking at least one reference point on the semantic map or the electronic map data comprises:
automatically determining a point in the target working area as the reference point according to the semantic map.

3. The method according to claim 2, wherein the automatically determining a point in the target working area as the reference point according to the semantic map comprises:
automatically determining a corner point of the workable area and/or a turning point of the workable area boundary as the reference point.

4. The method according to claim 1, wherein the marking at least one reference point on the semantic map or the electronic map data comprises:
presenting the semantic map or the electronic map data to a user;
receiving a selection operation of the user on the semantic map or the electronic map data; and
marking the reference point on the semantic map or the electronic map data according to the selection operation.

5. The method according to claim 1, further comprising:
generating a first drive circuit instruction, wherein the first drive circuit instruction instructs to move to the reference point or an adjacent range area of the reference point; and
executing, by the self-moving device, the first drive circuit instruction by performing positioning and based on coordinate information of the reference point.

6. The method according to claim 1, wherein the invoking a preset recognition model, and determining a semantic map based on the electronic map data comprises: invoking the preset recognition model, and generating one or more sub-areas based on the electronic map data, wherein the workable area of the semantic map comprises the sub-area; and
the marking at least one reference point on the semantic map comprises: marking at least one reference point in each sub-area.

7. The method according to claim 6, further comprising:
generating a second drive circuit instruction, wherein the second drive circuit instruction instructs to move, after movement is completed in a corresponding sub-area based on one of the reference points, to a reference point corresponding to another sub-area to start movement in the another sub-area.

8. The method according to claim 7, wherein
the semantic map further comprises a recognized passable non-working area and/or passable non-working area boundary, and the passable non-working area and/or passable non-working area boundary is correlated to the coordinate information; and
the moving, after movement is completed in a corresponding sub-area based on one of the reference points, to a reference point corresponding to another sub-area comprises: moving, after movement is completed in the corresponding sub-area based on one of the reference points, to the reference point corresponding to the another sub-area through the passable non-working area.

9. The method according to claim 1, further comprising:
recognizing the workable area boundary through visual recognition; and
generating a third drive circuit instruction based on the recognized boundary, wherein the third drive circuit instruction instructs to move along the workable area boundary and/or steer to move away from the workable area boundary.

10. The method according to claim 1, further comprising:
recognizing the workable area boundary through visual recognition;
operating the self-moving device to move along the workable area boundary, and recording the coordinate information in a movement process through positioning; and
generating a working area map of the target working area according to the recorded coordinate information.

11. The method according to claim 1, wherein the forming a movement path comprises forming a regular movement path.

12. The method according to claim 11, wherein the forming a regular movement path comprises:
generating a round-trip movement path, wherein the round-trip movement path comprises a former path section and a latter path section, and the latter path section is offset from the former path section by a preset distance.

13. The method according to claim 1, further comprising:
determining, through visual recognition, whether there is an obstacle at a position at a preset distance in front of a current position; and
generating an adjusted path if it is determined that there is an obstacle at the position at the preset distance in front of the current position, wherein the adjusted path is used for avoiding the obstacle.

14. The method according to claim 1, further comprising:
generating the movement path based on the integration of a positioning signal, wherein the positioning signal is obtained from inertial navigation, a speedometer or satellite navigation.

15. The method according to claim 1, wherein the electronic map database comprises an online satellite map database.

16. The method according to claim 1, wherein the invoking a preset recognition model, and determining a semantic map based on the electronic map data comprises: performing convolution processing on the image data in the electronic map data by using a trained neural network model, to obtain the semantic map.

17. The method according to claim 1, wherein the self-moving device comprises a self-moving lawn treatment device, and the target working area comprises a target lawn.

18. A computer-readable storage medium, storing computer instructions, the instructions, when executed, implementing the steps of:
obtaining electronic map data from an electronic map database, wherein the electronic map data comprises image data comprising a target working area, and the image data is correlated to coordinate information;
invoking a preset recognition model, and determining a semantic map based on the electronic map data, wherein the semantic map comprises a recognized workable area and/or workable area boundary, and the workable area and/or workable area boundary is correlated to the coordinate information;
marking at least one reference point on the semantic map or the electronic map data; and
forming a movement path by using the reference point as a start point and based on the workable area and/or workable area boundary on the semantic map.

19. An area division and path forming apparatus for a self-moving device, comprising:
an obtaining module, configured to obtain electronic map data from an electronic map database, wherein the electronic map data comprises image data comprising a target working area, and the image data is correlated to coordinate information;
a recognition module, configured to: invoke a preset recognition model, and determine a semantic map based on the electronic map data, wherein the semantic map comprises a recognized workable area and/or workable area boundary, and the workable area and/or workable area boundary is correlated to the coordinate information;
a marking module, configured to mark at least one reference point on the semantic map or the electronic map data; and
a movement path forming module, configured to form a movement path by using the reference point as a start point and based on the workable area and/or workable area boundary on the semantic map.

20. An area division and path forming apparatus for a self-moving device, comprising:
a memory, storing computer-readable instructions; and
a processor, when processing the computer-readable instructions, performing the following steps:
obtaining electronic map data from an electronic map database, wherein the electronic map data comprises image data comprising a target working area, and the image data is correlated to coordinate information;
invoking a preset recognition model, and determining a semantic map based on the electronic map data, wherein the semantic map comprises a recognized workable area and/or workable area boundary, and the workable area and/or workable area boundary is correlated to the coordinate information;
marking at least one reference point on the semantic map or the electronic map data; and
forming a movement path by using the reference point as a start point and based on the workable area and/or workable area boundary on the semantic map.

21. An automatic working system, comprising a self-moving device and an application installed on a user terminal side, wherein
the application comprises:
an obtaining procedure, comprising: obtaining electronic map data from an electronic map database, wherein the electronic map data comprises image data comprising a target working area, and the image data is correlated to coordinate information;
a recognition procedure, comprising: invoking a preset recognition model, and determining a semantic map based on the electronic map data, wherein the semantic map comprises a recognized workable area and/or workable area boundary, and the workable area and/or workable area boundary is correlated to the coordinate information; and
a marking procedure, comprising: marking at least one reference point on the semantic map or the electronic map data;
the self-moving device comprises a communication module, communicating with a client, and obtaining coordinate information of the reference point from the client after the application is executed; and
the self-moving device further comprises a positioning module, forming a movement path by monitoring an output of the positioning module and based on the coordinate information of the reference point.

22. An automatic working system, comprising: a self-moving device, wherein the self-moving device comprises a housing, a movement module mounted at the housing, and a control module controlling the movement module to drive the self-moving device to move; the self-moving device further comprises a positioning module, configured to output coordinate information of the self-moving device; the automatic working system further comprises a storage unit, storing:
a semantic map generation procedure, comprising:
obtaining electronic map data from an electronic map database, wherein the electronic map data comprises image data comprising a target working area, and the image data is correlated to the coordinate information;
invoking a preset recognition model, and determining a semantic map based on the electronic map data, wherein the semantic map comprises a recognized workable area and/or workable area boundary, and the workable area and/or workable area boundary is correlated to the coordinate information; and
a marking procedure, comprising: marking at least one reference point on the semantic map or the electronic map data;
the automatic working system executes the semantic map generation procedure and the marking procedure, to determine coordinate information of the reference point; and
the control module controls the movement module by monitoring an output of the positioning module and based on the coordinate information of the reference point to form a movement path.
